(19) United States
(12) Patent Application Publication
(10) Pub. No.: US 2022/0136473 A1
(43) Pub. Date: May 5, 2022

(54) FILTRATION DEVICE FOR A COMMON RAIL FUEL INJECTOR

(71) Applicant: Caterpillar Inc., Peoria, IL (US)

(72) Inventors: Daniel Richard IBRAHIM, East Peoria, IL (US); Michael Edward PICKELL, Washington, IL (US)

(73) Assignee: Caterpillar Inc., Peoria, IL (US)

(21) Appl. No.: 16/949,502

(22) Filed: Oct. 30, 2020

(51) Int. Cl. F02M 61/16; F02M 55/02; F02M 63/02

(52) U.S. Cl. CPC F02M 61/165; F02M 55/025; F02M 63/0275; F02M 2200/9053; F02M 2200/27; F02M 2200/8076; F02M 63/0265

(57) ABSTRACT

A filtration device may include a securement section and a filter. The securement section may be configured to be threadably secured to and extend within an interior of a common rail fuel injector. The securement section may include a passage for fuel. The passage may extend in a direction along a central axis of the securement section. The filter may be configured to be positioned within the interior of the common rail fuel injector to filter the fuel flowing through the common rail fuel injector. The filter may include a plurality of holes that are fluidly connecting to the passage of the securement section. The diameter of the filter may be smaller than a diameter of the securement section.

### TECHNICAL FIELD

The present disclosure relates generally to a filtration device and, for example, to a filtration device for a common rail fuel injector.

### BACKGROUND

A diesel fuel injection system (e.g., a common rail injection system, a pump-line-nozzle injection system, and/or the like) delivers atomized fuel into cylinders of an engine. The engine, in turn, converts chemical energy stored in the fuel into mechanical work (e.g., to propel a vehicle, power a generator, and/or the like). By delivering the fuel in an atomized state, the diesel fuel injection system increases power and fuel economy of the engine and decreases noise. However, due to the high injection pressure of the fuel, which may range from 10,000 pounds per square inch (psi) to 40,000 psi, components of the diesel fuel injection system may be susceptible to damage and/or leaks.

Furthermore, the presence of debris particles in the fuel (e.g., dust, rust, sand, and/or the like) may render some components even more susceptible to damage and/or leaks. For example, as the fuel passes through a fuel injector of the diesel fuel injection system, the debris particles may build up within a passage and obstruct the fuel. As a result, the fuel injector may provide insufficient fuel to the engine to produce a desired output. In some cases, the debris particles may damage the fuel injector and/or one or more other components of the diesel fuel injection system.

One attempt to mitigate harm from the debris particles in the fuel is disclosed in U.S. Pat. No. 7,070,127 (the '127 patent), which issued to Dieter Maier on Jul. 4, 2006. In particular, the '127 patent discloses a fuel injector for fuel-injection systems of internal combustion engines. The fuel injector includes a sleeve integrally formed with a filter element to form a one-part, deep-drawn filter sleeve. The filter sleeve has through-flow openings for filtering the fuel flowing through the fuel injector.

The filtration device of the present disclosure solves one or more of the problems set forth above and/or other problems in the art.

### SUMMARY

In some implementations, a filtration device includes a securement section that is configured to be threadably secured to and extend within an interior of a common rail fuel injector, wherein the securement section includes a passage for fuel, wherein the passage extends in a direction along a central axis of the securement section; and a filter that is configured to be positioned within the interior of the common rail fuel injector to filter the fuel flowing through the common rail fuel injector, wherein the filter includes a plurality of holes that are fluidly connected to the passage of the securement section, wherein a diameter of the filter is smaller than a diameter of the securement section.

In some implementations, a fuel injector includes an inlet portion comprising: an interior cylindrical surface having a first screw thread, and an interior bottom surface, wherein the interior cylindrical surface and the interior bottom surface together define a cavity having a first diameter; a securement section comprising: an exterior surface having a second screw thread to engage the first screw thread, and a passage extending along a central axis of the securement section; and a filter positioned within the cavity of the inlet portion of the fuel injector, the filter comprising: a plurality of holes that are fluidly connected to the passage of the securement section, wherein the filter has a diameter that is less than a diameter of the cavity.

In some implementations, a fuel system includes a common rail; and a plurality of fuel injectors configured to receive fuel from the common rail, a fuel injector of the plurality of fuel injectors comprising: an inlet portion having a cavity that includes a first screw thread; an securement section having: a second screw thread to engage the first screw thread, and a passage extending along a central axis of the securement section; and a filter positioned within the cavity of the inlet portion of the fuel injector, the filter having a plurality of holes that are fluidly connected to the passage of the securement section wherein the filter has a diameter that is less than a diameter of the cavity.

### BRIEF DESCRIPTION OF THE DRAWINGS

FIG. 1 is a diagram of an example fuel system, according to one or more aspects of the present disclosure.

FIG. 2 is a diagram of an example fuel injector having a filtration device, according to one or more aspects of the present disclosure.

FIG. 3 is a diagram of an example fuel injector having a filtration device, according to one or more aspects of the present disclosure.

FIG. 4 is a diagram of an example fuel injector having a filtration device, according to one or more aspects of the present disclosure.

FIG. 5 is a diagram of an example fuel injector having a filtration device, according to one or more aspects of the present disclosure.

FIG. 6 is a diagram of an example fuel injector having a filtration device, according to one or more aspects of the present disclosure.

### DETAILED DESCRIPTION

This disclosure relates to a filtration device, which is applicable to any system involved in filtering fluid. For example, the system may be a fuel system, a power system, and/or the like. The system may be implemented in a vehicle (e.g., a motor vehicle, a railed vehicle, a watercraft, an aircraft, and/or the like), a generator, and/or the like.

To simplify the explanation below, the same reference numbers may be used to denote like features. The drawings may not be to scale.

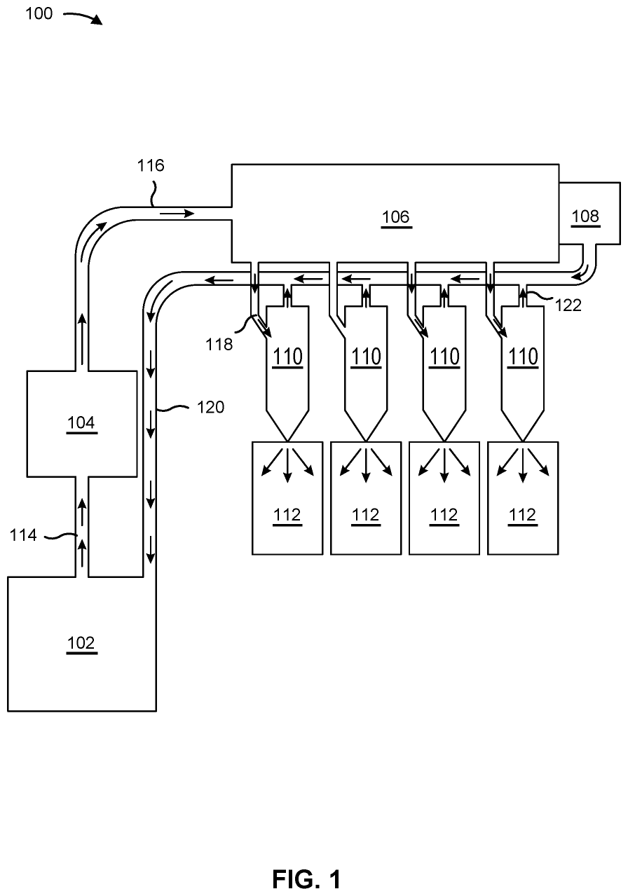

FIG. 1 is a diagram of an example fuel system 100. The fuel system 100 is configured to control delivery of fuel to allow chemical energy stored in the fuel to be converted into mechanical work (e.g., to propel a vehicle). The fuel system 100 includes a fuel tank 102, a pump 104, a common rail 106, a pressure limiter 108, and a plurality of fuel injectors 110 (e.g., 6 fuel injectors, 8 fuel injectors, 12 fuel injectors, and/or the like). The plurality of fuel injectors 110 are positioned to discharge the atomized fuel directly into combustion chambers within a plurality of cylinders 112 (e.g., 6 cylinders, 8 cylinders, 12 cylinders, and/or the like). In some implementations, the fuel system 100 may include an electronic control unit, one or more sensors, one or more additional pumps, and/or the like.

The fuel tank 102 is a storage tank configured to store fuel. The fuel may be introduced into the fuel tank 102 via a sealable opening and may be configured to travel, via a first fuel delivery line 114, from the fuel tank 102 to the pump 104. The fuel is a fluid that is configured to combust within the plurality of cylinders 112 to drive a drivetrain. For example, the fuel may be a diesel fuel, such as petroleum diesel fuel, a synthetic diesel fuel, a biodiesel fuel, and/or the like. Due to environmental conditions, the fuel may contain debris particles (e.g., dust, rust, sand, and/or the like), which may vary in size and/or material.

The pump 104 is a mechanism that is configured to pressurize the fuel at a pressure that allows proper combustion. For example, the pressure may be in a range of approximately 10,000 psi to approximately 40,000 psi. After the pump 104 pressurizes the fuel, the pump 104 is configured to deliver the pressurized fuel along a second fuel delivery line 116 to the common rail 106. The common rail 106, in turn, is a conduit that is configured to distribute the pressurized fuel along a plurality of third fuel delivery lines 118 to the plurality of fuel injectors 110. The common rail 106 may be further configured to expel an excess amount of the fuel into the pressure limiter 108, which is a mechanism that is configured to route the excess fuel, via a first fuel return line 120, back to the fuel tank 102.

The plurality of fuel injectors 110 are mechanisms that are configured to introduce the pressurized fuel into the plurality of cylinders 112. The plurality of fuel injectors 110 are further configured to expel bypass fuel along a plurality of second fuel return lines 122 into the first fuel return line 120 to travel back to the fuel tank 102. The plurality of cylinders 112 are engine components. Each includes a respective piston movably mounted therein to travel in a 4-stroke cycle to cause the fuel to combust, which drives the drivetrain. The plurality of cylinders 112 may be arranged in an in-line configuration, a “V” configuration, or another suitable configuration.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, differently arranged devices than those shown in FIG. 1. Furthermore, two or more devices shown in FIG. 1 may be implemented within a single device, or a single device shown in FIG. 1 may be implemented as multiple, distributed devices.

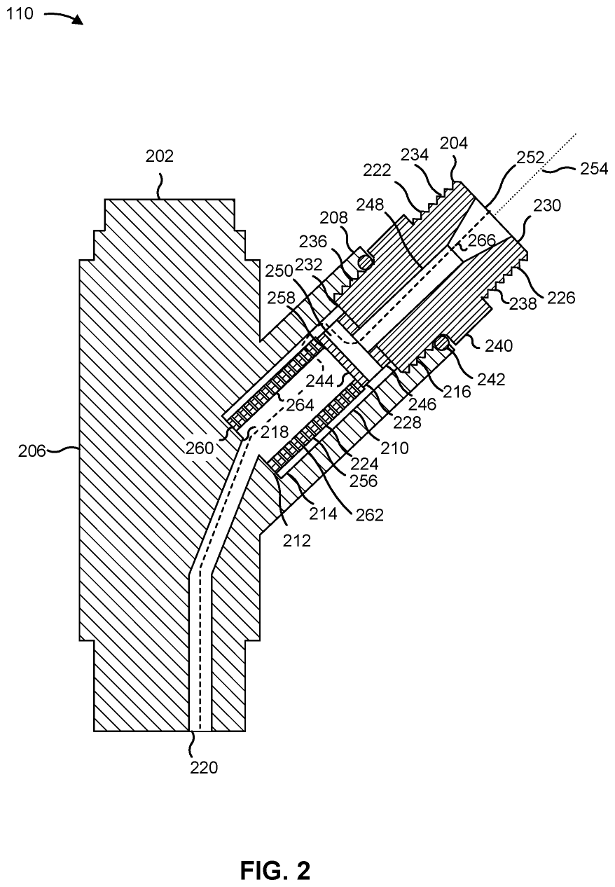

FIG. 2 is a diagram of a portion of a fuel injector 110 (e.g., of the plurality of fuel injectors 110), according to one or more aspects of the present disclosure. As shown in FIG. 2, the fuel injector 110 includes a fuel injector body 202 and a filtration device 204 removably secured therein. The fuel injector body 202 is structured and arranged to control dispersion of the pressurized fuel into a cylinder 112 (e.g., of the plurality of cylinders 112). For example, the fuel injector body 202 may house a plurality of components (e.g., a solenoid, one or more valves, and/or the like), which together may control timing of the dispersion, an amount of the dispersion, and/or the like. The filtration device 204 is structured and arranged within the fuel injector body 202 to prevent the debris particles within the pressurized fuel from obstructing flow of the pressurized fuel through the fuel injector body 202 and/or damaging the fuel injector body 202 and/or other components.

The fuel injector body 202 includes a main body portion 206 and an inlet portion 208 extending angularly therefrom. The main body portion 206 and the inlet portion 208 may each be substantially cylindrical. The fuel injector body 202 may be made of an alloy, such as steel (e.g., American Iron and Steel Institute (AISI) 4140 steel, AISI 4120 steel, and/or the like). Other materials, shapes, and sizes of the fuel injector body 202 are possible.

The inlet portion 208 includes an interior cylindrical surface 210 and an interior bottom surface 212, which together define a cavity 214. The interior cylindrical surface 210 includes a first screw thread 216 at an upper end thereof. The interior bottom surface 212 includes an opening 218, which is configured to fluidly communicate with a channel 220 inside the main body portion 206 to allow the pressurized fuel to flow through the main body portion 206, where other components of the fuel injector 110 interact with the fuel to control the flow of the fuel into the cylinder 112.

In an exemplary embodiment, the cavity 214 may have a diameter in a range of approximately 9 millimeters (mm) to approximately 12 mm. A diameter of the channel 220 is smaller than the diameter of the cavity 214. In such example, the diameter of the channel 220 may be in a range of approximately 2.5 mm to approximately 3.5 mm.

The filtration device 204 includes a securement section 222 and a filter 224. The securement section 222 has a first body portion 226 integrally connected to a second body portion 228. The first body portion 226 has a first exterior top surface 230, a first exterior bottom surface 232, and a first exterior lateral surface 234 connecting the first exterior top surface 230 to the first exterior bottom surface 232. The first exterior lateral surface 234 includes a second screw thread 236, a third screw thread 238, and a projection 240 (e.g., a hexagonal projection, a winged projection, and/or the like) therebetween. The second screw thread 236 is configured to engage the first screw thread 216, and the third screw thread 238 is configured to engage a fourth screw thread within the third fuel delivery line 118.

The projection 240 facilitates attachment of the securement section 222 with the inlet portion 208. For example, a user may manually grip the projection 240 to threadably insert the filtration device 204 into the fuel injector body 202. As a further example, the user may use a wrench or another tool to grip the projection 240 to threadably insert the filtration device 204 into the fuel injector body 202. Once so secured, the securement section 222 forms a junction between the third fuel delivery line 118 and the fuel injector body 202 to allow the pressurized fuel to flow therebetween. In some implementations, to create a seal, a gasket 242 may be secured to the first exterior lateral surface 234 of the first body portion 226 between the projection 240 and the cavity 214 of the inlet portion 208.

As further shown in FIG. 2, the second body portion 228 has a second exterior bottom surface 244 and a second exterior cylindrical surface 246 that connects the second exterior bottom surface 244 to the first exterior bottom surface 232 of the first body portion 226. To guide the pressurized fuel from the third fuel delivery line 118 into the cavity 214 for filtration, the securement section 222 includes a first passage 248 that fluidly communicates (e.g., intersects) with a second passage 250. The first passage 248 and the second passage 250 may be substantially cylindrical bores. In some implementations, to facilitate passage of the pressurized fuel from the third fuel delivery line 118 into and along the first passage 248, the first passage 248 may include a tapered opening 252. The first passage 248 extends in a direction along a central axis 254 of the securement section 222 from the first exterior top surface 230 of the first body portion 226 into the second body portion 228. The second passage 250, in turn, extends through the second exterior cylindrical surface 246 in a direction substantially perpendicular to the central axis 254. In this way, the second passage 250 may form a T-intersection with the first passage 248.

The filter 224 includes a substantially cylindrical filter body 256 disposed within the cavity 214 of the inlet portion 208 to prevent the debris particles from exiting the cavity 214 while the pressurized fuel flows from an exterior side of the filter 224 to an interior side of the filter 224. The filter body 256 has a first open end 258, a second open end 260, and a wall 262 connecting the first open end 258 to the second open end 260. The first open end 258 is integrally connected to the second exterior bottom surface 244 of the second body portion 228. The second open end 260 is configured to abut the interior bottom surface 212 of the cavity 214 to form a seal therewith. The wall 262 includes a plurality of holes 264 extending radially therethrough. Each of the plurality of holes 264 extends in a direction that is substantially perpendicular to the direction of the first passage 248. In some implementations, the plurality of holes 264 may be disposed at an angle with respect to the direction of the first passage 248 (e.g., a 100 degree angle, a 135 degree angle, and/or the like).

The filtration device 204 may be formed from a single, integral piece of material, such as steel (e.g., American Iron and Steel Institute (AISI) 4140 steel, AISI 4120 steel, and/or the like). To securely fit within the inlet portion 208, the first body portion 226 has a diameter substantially equal to the diameter of the cavity 214. For example, the diameter of the first body portion 226 may be in a range of approximately 9 mm to approximately 12 mm. To allow the pressurized fuel to flow from the second passage 250 into the cavity 214, a diameter of the second body portion 228 is smaller than the diameter of the cavity 214. In the example described above, the diameter of the second body portion 228 may in a range of approximately 8 mm to approximately 11 mm. To trap the debris particles between the wall 262 of the filter body 256 and the interior cylindrical surface 210 of the cavity 214, a diameter of the filter 224 is likewise smaller than the diameter of the cavity 214. In the example described above, the diameter of the filter 224 may be in a range of approximately 8 mm to approximately 11 mm. Each of the plurality of holes 264 is sized to prevent the debris particles from entering the channel 220 of the fuel injector body 202. For example, each of the plurality of holes 264 may have a diameter of approximately 0.07 mm. Other materials, shapes, and sizes of the filtration device 204 are possible.

In use, fuel may travel along any number of paths to pass through the filtration device 204. For example, while traveling along a path 266, the fuel may enter the tapered opening 252 of the securement section 222 and flow along the first passage 248 and the second passage 250. After exiting the second passage 250 into the cavity 214, the fuel may enter the filter 224 via a hole 264, and flow through the channel 220 into the fuel injector 110. In such a process, the filter 224 may prevent the debris particles from exiting the cavity 214.

As indicated above, FIG. 2 is provided as an example. Other examples may differ from what is described with regard to FIG. 2. The fuel injector 110 of FIG. 2 may include additional components, fewer components, different components, differently arranged components, and/or differently shaped components than those shown in FIG. 2. For example, in some implementations, the inlet portion 208 of the fuel injector body 202 may be coaxially aligned with the main body portion 206. As a further example, the second body portion 228 of the securement section 222 may include one or more additional passages that extend in a direction substantially perpendicular to the central axis 254 of the securement section 222.

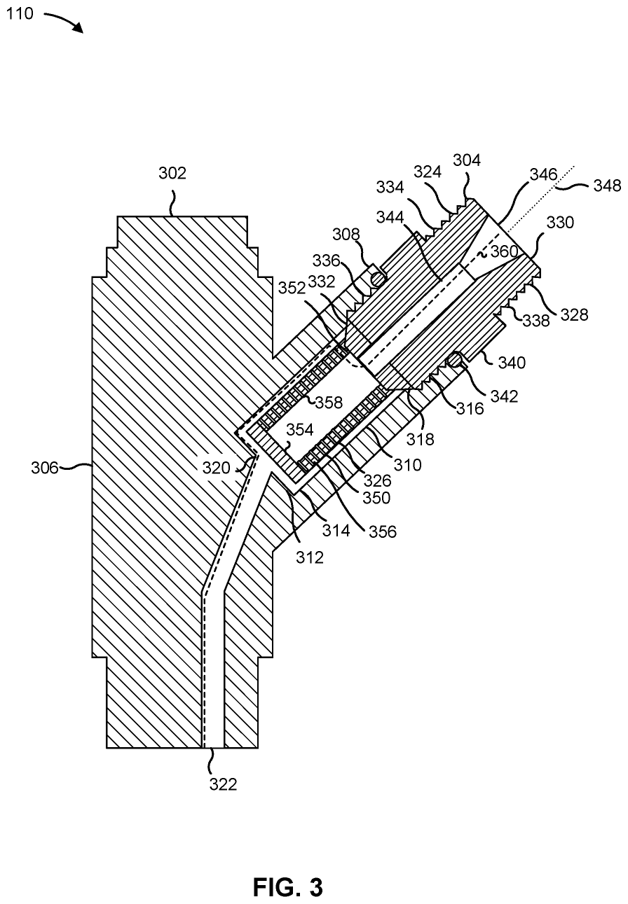

FIG. 3 is a diagram of a fuel injector 110 (e.g., of the plurality of fuel injectors 110), according to one or more aspects of the present disclosure. As shown in FIG. 3, the fuel injector 110 includes a fuel injector body 302 and a filtration device 304 removably secured therein.

The fuel injector body 302 includes a main body portion 306 and an inlet portion 308 extending angularly therefrom. The inlet portion 308 includes an interior cylindrical surface 310 and an interior bottom surface 312, which together define a cavity 314. The cavity 314 has a substantially cylindrical shape. The interior cylindrical surface 310 includes a first screw thread 316 adjacent to an angled seat 318. The first screw thread 316 is arranged at an upper end of the interior cylindrical surface 310, and the angled seat 318 is arranged between the first screw thread 316 and the interior bottom surface 312. The interior bottom surface 312 includes an opening 320, which is configured to fluidly communicate with a channel 322 inside the main body portion 306 to allow the pressurized fuel to flow through the main body portion 306 and into the cylinder 112.

The fuel injector body 302 may be made of an alloy, such as steel (e.g., American Iron and Steel Institute (AISI) 4140 steel, AISI 4120 steel, and/or the like). The cavity 314 has a diameter in a range of approximately 9 mm to approximately 12 mm. A diameter of the channel 322 is smaller than the diameter of the cavity 314. For example, the diameter of the channel 322 may be in a range of approximately 2.5 mm to approximately 3.5 mm. Other materials, shapes, and sizes of the fuel injector body 302 are possible.

The filtration device 304 includes a securement section 324 integrally connected to a filter 326. The securement section 324 has a securement section body 328 having a first end 330, a second end 332, and an exterior surface 334 connecting the first end 330 to the second end 332. The second end 332 is configured to abut the angled seat 318 of the inlet portion 308 to be supported thereby and to form a seal. The exterior surface 334 includes a second screw thread 336, a third screw thread 338, and a projection 340 (e.g., a hexagonal projection, a winged projection, and/or the like) therebetween. The second screw thread 336 is configured to engage the first screw thread 316, and the third screw thread 338 is configured to engage a fourth screw thread within the third fuel delivery line 118.

The projection 340 facilitates attachment of the securement section 324 with the inlet portion 308. For example, a user may manually grip the projection 340 to threadably insert the filtration device 304 into the fuel injector body 302. As a further example, the user may use a wrench or another tool to grip the projection 340 to threadably insert the filtration device 304 into the fuel injector body 302. Once so secured, the securement section 324 may form a junction between the third fuel delivery line 118 and the fuel injector body 302 to allow the pressurized fuel to flow therebetween. In some implementations, to create a seal, a gasket 342 may be secured to the exterior surface 334 of the securement section body 328 between the projection 340 and the cavity 314 of the inlet portion 308.

To guide the pressurized fuel from the third fuel delivery line 118 into the filter 326 for filtration, the securement section 324 includes a passage 344 that has a tapered opening 346. The passage 344 defines a through hole that extends in a direction along a central axis 348 of the securement section 324 from first end 330 to the second end 332 of the securement section 324.

The filter 326 includes a filter body 350 that is configured to be arranged within the cavity 314 of the inlet portion 308 to prevent the debris particles from exiting the cavity 314 while the pressurized fuel flows from an interior side of the filter 326 to an exterior side of the filter 326. To form a receptacle for the debris particles, the filter body 350 has a first open end 352, a second closed end 354, and a wall 356 connecting the first open end 352 to the second closed end 354. The filter body 350 has a substantially cylindrical shape. The first open end 352 is integrally connected to the second end 332 of the securement section body 328. The second closed end 354 is configured to be spaced apart from the interior bottom surface 312 of the cavity 314. The wall 356 includes a plurality of holes 358 extending radially therethrough. Each of the plurality of holes 358 extends in a direction that is substantially perpendicular to the direction of the passage 344.

The filtration device 304 may be formed from a single, integral piece of material, such as steel (e.g., American Iron and Steel Institute (AISI) 4140 steel, AISI 4120 steel, and/or the like). To securely fit within the inlet portion 308, the securement section body 328 has a diameter substantially equal to the diameter of the cavity 314. For example, the diameter of the securement section body 328 may be in a range of approximately 9 mm to approximately 12 mm. To allow the pressurized fuel to flow from the filter 326 into the channel 322 of the fuel injector body 302, a diameter of the filter 326 is smaller than the diameter of the cavity 314. For example, the diameter of the filter 326 may be in a range of approximately 8 mm to approximately 11 mm. Each of the plurality of holes 358 is sized to prevent the debris particles from exiting the receptacle of the filter body 350. For example, each of the plurality of holes 358 may have a diameter of approximately 0.07 mm. Other materials, shapes, and sizes of the filtration device 304 are possible.

In use, fuel may travel along any number of paths to pass through the filtration device 304. For example, while traveling along a path 360, the fuel may enter the tapered opening 346 of the securement section 324 and flow along the passage 344. After exiting the passage 344, the fuel may pass through a hole 358 of the filter 326 and flow through the channel 322 into a fuel injector 110. In such a process, similar to that described above, the filter 326 may prevent the debris particles from exiting the cavity 314.

As indicated above, FIG. 3 is provided as an example. Other examples may differ from what is described with regard to FIG. 3. The fuel injector 110 of FIG. 3 may include additional components, fewer components, different components, differently arranged components, and/or differently shaped components than those shown in FIG. 3. For example, in some implementations, the inlet portion 308 of the fuel injector body 302 may be coaxially aligned with the main body portion 306.

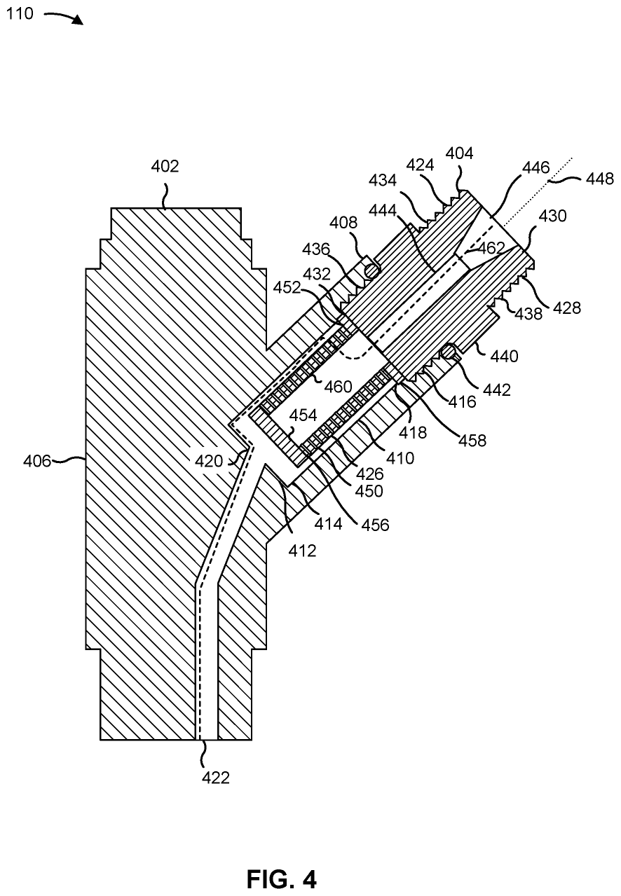

FIG. 4 is a diagram of a fuel injector 110 (e.g., of the plurality of fuel injectors 110), according to one or more aspects of the present disclosure. As shown in FIG. 4, the fuel injector 110 includes a fuel injector body 402 and a filtration device 404 removably secured therein.

The fuel injector body 402 includes a main body portion 406 and an inlet portion 408 extending angularly therefrom. The inlet portion 408 includes an interior cylindrical surface 410 and an interior bottom surface 412, which together define a cavity 414. The cavity 414 has a substantially cylindrical shape. The interior cylindrical surface 410 includes a first screw thread 416 adjacent to a seat 418. The first screw thread 416 is arranged at an upper end of the interior cylindrical surface 410, and the seat 418 is arranged between the first screw thread 416 and the interior bottom surface 412. The interior bottom surface 412 includes an opening 420, which is configured to fluidly communicate with a channel 422 inside the main body portion 406 to allow the pressurized fuel to flow through the main body portion 406 and into the cylinder 112.

The fuel injector body 402 may be made of an alloy, such as steel (e.g., American Iron and Steel Institute (AISI) 4140 steel, AISI 4120 steel, and/or the like). The cavity 414 has a diameter in a range of approximately 9 mm to approximately 12 mm. A diameter of the channel 422 is smaller than the diameter of the cavity 414. For example, the diameter of the channel 422 may be in a range of approximately 2.5 mm to approximately 3.5 mm. Other materials, shapes, and sizes of the fuel injector body 402 are possible.

The filtration device 404 includes a securement section 424 and a filter 426. The securement section 424 has a securement section body 428 having a first end 430, a second end 432, and an exterior surface 434 connecting the first end 430 to the second end 432. The exterior surface 434 includes a second screw thread 436, a third screw thread 438, and a projection 440 (e.g., a hexagonal projection, a winged projection, and/or the like) therebetween. The second screw thread 436 is configured to engage the first screw thread 416, and the third screw thread 438 is configured to engage a fourth screw thread within the third fuel delivery line 118.

The projection 440 facilitates attachment of the securement section 424 with the inlet portion 408. For example, a user may manually grip the projection 440 to threadably insert the filtration device 404 into the fuel injector body 402. As a further example, the user may use a wrench or another tool to grip the projection 440 to threadably insert the filtration device 404 into the fuel injector body 402. Once so secured, the securement section 424 may form a junction between the third fuel delivery line 118 and the fuel injector body 402 to allow the pressurized fuel to flow therebetween. In some implementations, to create a seal, a gasket 442 may be secured to the exterior surface 434 of the securement section body 428 between the projection 440 and the cavity 414 of the inlet portion 408. To guide the pressurized fuel from the third fuel delivery line 118 into the filter 426 for filtration, the securement section 424 includes a passage 444 that has a tapered opening 446. The passage 444 defines a through hole that extends in a direction along a central axis 448 of the securement section 424 from first end 430 to the second end 432 of the securement section 424.

The filter 426 includes a filter body 450 that is configured to be arranged within the cavity 414 of the inlet portion 408 to prevent the debris particles from exiting the cavity 414 while the pressurized fuel flows from an interior side of the filter 426 to an exterior side of the filter 426. To form a receptacle for the debris particles, the filter body 450 has a first open end 452, a second closed end 454, and a wall 456 connecting the first open end 452 to the second closed end 454. The filter body 450 has a substantially cylindrical shape. The first open end 452 includes a flange 458 that is configured to be clamped between the seat 418 of the inlet portion 408 and the second end 432 of the securement section 424. The second closed end 454 is configured to be spaced apart from the interior bottom surface 412 of the cavity 414. The wall 456 includes a plurality of holes 460 extending radially therethrough. Each of the plurality of holes 460 extends in a direction that is substantially perpendicular to the direction of the passage 444.

The filtration device 404 may be formed from a material such as steel (e.g., American Iron and Steel Institute (AISI) 4140 steel, AISI 4120 steel, and/or the like). To securely fit within the inlet portion 408, the securement section body 428 has a diameter substantially equal to the diameter of the cavity 414. For example, the diameter of the securement section body 428 may be in a range of approximately 9 mm to approximately 12 mm. To allow the pressurized fuel to flow from the filter 426 into the channel 422 of the fuel injector body 402, a diameter of the filter 426 is smaller than the diameter of the cavity 414. For example, the diameter of the filter 426 may be in a range of approximately 8 mm to approximately 11 mm. Each of the plurality of holes 460 is sized to prevent the debris particles from exiting the receptacle of the filter body 450. For example, each of the plurality of holes 460 may have a diameter of approximately 0.07 mm. Other materials, shapes, and sizes of the filtration device 404 are possible.

In use, fuel may travel along any number of paths to pass through the filtration device 404. For example, the fuel may travel along a path 462, which is substantially the same as the path 360 of FIG. 3.

As indicated above, FIG. 4 is provided as an example. Other examples may differ from what is described with regard to FIG. 4. The fuel injector 110 of FIG. 4 may include additional components, fewer components, different components, differently arranged components, and/or differently shaped components than those shown in FIG. 4. For example, in some implementations, the inlet portion 408 of the fuel injector body 402 may be coaxially aligned with the main body portion 406.

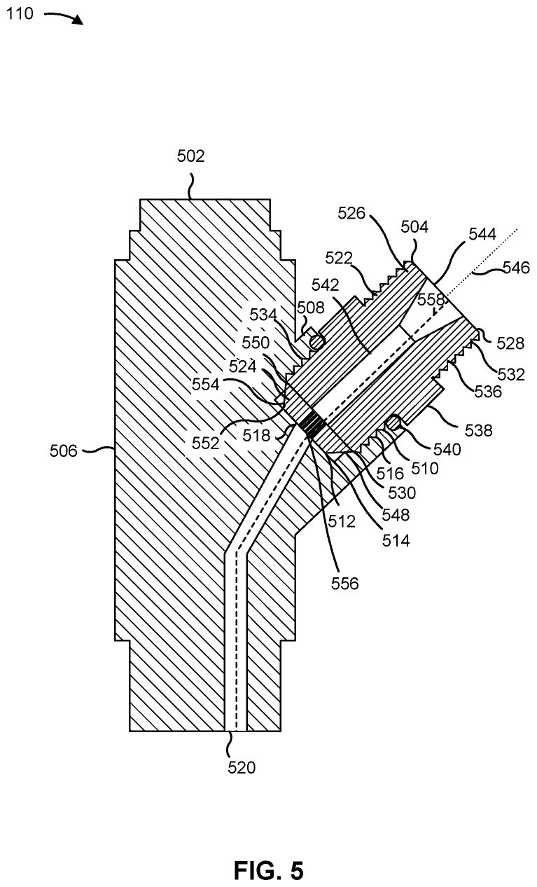

FIG. 5 is a diagram of a fuel injector 110 (e.g., of the plurality of fuel injectors 110), according to one or more aspects of the present disclosure. As shown in FIG. 5, the fuel injector 110 includes a fuel injector body 502 and a filtration device 504 removably secured therein. Similar to that described above with respect to FIGS. 2-4, the fuel injector body 502 is structured and arranged to control dispersion of the pressurized fuel into a cylinder 112 (e.g., of the plurality of cylinders 112). The filtration device 504 is structured and arranged within the fuel injector body 502 to prevent the debris particles within the pressurized fuel from obstructing flow of the pressurized fuel and/or damaging the fuel injector body 502.

The fuel injector body 502 includes a main body portion 506 and an inlet portion 508 extending angularly therefrom. The inlet portion 508 includes an interior cylindrical surface 510 and an interior bottom surface 512, which together define a cavity 514. The cavity 514 has a substantially cylindrical shape. The interior cylindrical surface 510 includes, at an upper end thereof, a first screw thread 516. The interior bottom surface 512 includes an opening 518, which is configured to fluidly communicate with a channel 520 inside the main body portion 506 to allow the pressurized fuel to flow through the main body portion 506 and into the cylinder 112.

The fuel injector body 502 may be made of an alloy, such as steel (e.g., American Iron and Steel Institute (AISI) 4140 steel, AISI 4120 steel, and/or the like). The cavity 514 has a diameter in a range of approximately 9 mm to approximately 12 mm. A diameter of the channel 520 is smaller than the diameter of the cavity 514. For example, the diameter of the channel 520 may be in a range of approximately 2.5 mm to approximately 3.5 mm. Other materials, shapes, and sizes of the fuel injector body 502 are possible.

The filtration device 504 includes a securement section 522 integrally connected to a filter 524. The securement section 522 has a securement section body 526 having a first end 528, a second end 530, and an exterior surface 532 connecting the first end 528 to the second end 530. The exterior surface 532 includes a second screw thread 534, a third screw thread 536, and a projection 538 (e.g., a hexagonal projection, a winged projection, and/or the like) therebeween. The second screw thread 534 is configured to engage the first screw thread 516, and the third screw thread 536 is configured to engage a fourth screw thread within the third fuel delivery line 118.

The projection 538 facilitates attachment of the securement section 522 with the inlet portion 508. For example, a user may manually grip the projection 538 to threadably insert the filtration device 504 into the fuel injector body 502. As a further example, the user may use a wrench or another tool to grip the projection 538 to threadably insert the filtration device 504 into the fuel injector body 502. Once so secured, the securement section 522 may form a junction between the third fuel delivery line 118 and the fuel injector body 502 to allow the pressurized fuel to flow therebetween. In some implementations, to create a seal, a gasket 540 may be secured to the exterior surface 532 of the securement section body 526 between the projection 538 and the cavity 514 of the inlet portion 508. To guide the pressurized fuel from the third fuel delivery line 118 into the filter 524, the securement section 522 includes a passage 542 that has a tapered opening 544. The passage 542 defines a through hole that extends in a direction along a central axis 546 of the securement section 522 from first end 528 to the second end 530 of the securement section 522.

The filter 524 includes a filter body 548 that is configured to be arranged within the cavity 514 of the inlet portion 508 to prevent the debris particles from exiting the cavity 514 while the pressurized fuel flows from an interior side of the filter 524 to an exterior side of the filter 524. To define a shape substantially in the form of a truncated cone, the filter body 548 has an upper end 550, a lower end 552, and a tapered wall 554 connecting the upper end 550 to the lower end 552. The upper end 550 is integrally connected to the second end 530 of the securement section body 526. The lower end 552 is configured to abut the interior bottom surface 512 of the cavity 514. A plurality of holes 556 extend from the upper end 550 of the filter body 548 to the lower end 552 of the filter body 548 to fluidly communicate with the passage 542. Each of the plurality of holes 556 extends in a direction that is substantially parallel to the direction of the passage 542.

The filtration device 504 may be formed from a single, integral piece of material, such as steel (e.g., American Iron and Steel Institute (AISI) 4140 steel, AISI 4120 steel, and/or the like). To securely fit within the inlet portion 508, the securement section body 526 has a diameter substantially equal to the diameter of the cavity 514. For example, the diameter of the securement section body 526 may be in a range of approximately 9 mm to approximately 12 mm. Each of the plurality of holes 556 is sized to prevent the debris particles from exiting the passage 542 of the securement section 522. For example, each of the plurality of holes 556 may have a diameter of approximately 0.07 mm. Other materials, shapes, and sizes of the filtration device 504 are possible.

In use, fuel may travel along any number of paths to pass through the filtration device 504. For example, while traveling along a path 558, the fuel may enter the tapered opening 544 of the securement section 522 and flow along the passage 542. After exiting the passage 542, the fuel may pass through a hole 556 of the filter 524 and flow through the channel 520 into a fuel injector 110. In such a process, similar to that described above, the filter 524 may prevent the debris particles from exiting the cavity 514.

As indicated above, FIG. 5 is provided as an example. Other examples may differ from what is described with regard to FIG. 5. The fuel injector 110 of FIG. 5 may include additional components, fewer components, different components, differently arranged components, and/or differently shaped components than those shown in FIG. 5. For example, in some implementations, the inlet portion 508 of the fuel injector body 502 may be coaxially aligned with the main body portion 506.

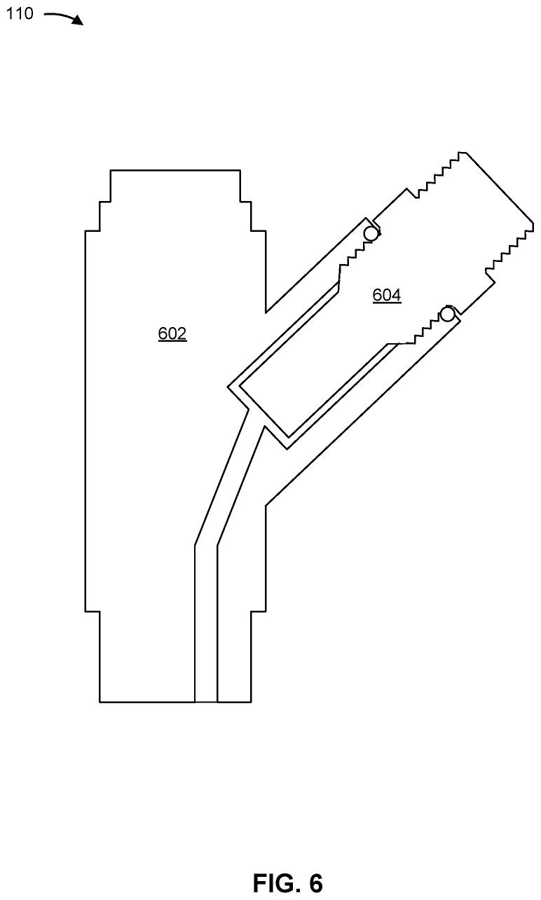

FIG. 6 is a diagram of a fuel injector 110 according to one or more aspects of the present disclosure. As shown in FIG. 6, the fuel injector 110 includes a fuel injector body 602 and a filtration device 604 threadably secured therein. Similar to that described above with respect to FIGS. 2-5, the fuel injector body 602 is structured and arranged to control dispersion of the pressurized fuel into a cylinder 112 (e.g., of the plurality of cylinders 112). The filtration device 604 is structured and arranged within the fuel injector body 602 to prevent the debris particles within the pressurized fuel from obstructing flow of the pressurized fuel and/or damaging the fuel injector body 602.

The fuel injector body 602 may include one or more features described above with respect to the fuel injector 110 of FIGS. 2-5. For example, the fuel injector body 602 may include one or more features of the fuel injector body 202, the fuel injector body 302, the fuel injector body 402, the fuel injector body 502, and/or a combination thereof. In other words, the fuel injector body 602 may include any single feature of the fuel injector body 202, the fuel injector body 302, the fuel injector body 402, and/or the fuel injector body 502; any combination of features of the fuel injector body 202, the fuel injector body 302, the fuel injector body 402, and/or the fuel injector body 502; or one or more features different than the features described in connection with the fuel injector body 202, the fuel injector body 302, the fuel injector body 402, and/or the fuel injector body 502.

Similarly, the filtration device 604 may include one or more features described above with respect to the fuel injector 110 of FIGS. 2-5. For example, the filtration device 604 may include one or more features of the filtration device 204, the filtration device 304, the filtration device 404, the filtration device 504, and/or a combination thereof. In other words, the filtration device 604 may include any single feature of the filtration device 204, the filtration device 304, the filtration device 404, and/or the filtration device 504; any combination of features of the filtration device 204, the filtration device 304, the filtration device 404, and/or the filtration device 504; or one or more features different than the features described in connection with the filtration device 204, the filtration device 304, the filtration device 404, and/or the filtration device 504.

As indicated above, FIG. 6 is provided as an example. Other examples may differ from what is described with regard to FIG. 6. The fuel injector 110 of FIG. 5 may include additional components, fewer components, different components, differently arranged components, and/or differently shaped components than those shown in FIG. 6.

A fuel system 100 has been described in connection with FIG. 1 as having a plurality of fuel injectors 110. Various types of the fuel injectors 110, in turn, have been described in connection with FIGS. 2-6. It should be understood that the fuel system 100 may include a single type of fuel injector 110 (e.g., the fuel injector 110 of FIG. 2, and/or the like) or a combination of two or more types of fuel injectors 110 (e.g., the fuel injector 110 of FIG. 2 and the fuel injector 110 of FIG. 3, and/or the like).

### INDUSTRIAL APPLICABILITY

The filtration device 204, 304, 404, 504, 604 of the present disclosure is particularly applicable within the fuel injector 110 of the fuel system 100. The fuel system 100 may be configured to utilize fuel (e.g., diesel fuel) to propel a vehicle (e.g., a motor vehicle, a railed vehicle, a watercraft, an aircraft, and/or the like), power a generator, and/or the like.

Because the filtration device 204, 304, 404, 504, 604 is threadably secured within the fuel injector body 202, 302, 402, 502, 602, rather than secured therein via a friction-fit attachment, the filtration device 204, 304, 404, 504, 604 of the present disclosure is easier to install and less likely to dislodge debris particles into the fuel during installation (e.g., by carving out a fragment of the filtration device and/or the fuel injector body). Thus, the filtration device 204, 304, 404, 504, 604 is designed to mitigate, rather than exacerbate, harm from debris particles that may be present within the fuel. Furthermore, by using a plurality of holes 264, 358, 460, 556, rather than slots, to filter the debris particles, the filtration device 204, 304, 404, 504, 604 is capable of blocking debris particles that may have otherwise passed through the slots. Thus, the filtration device 204, 304, 404, 504, 604 has improved filtration capability, and as a result, may extend service life of the fuel injector 110 and reduce costs associated with replacement and/or repair.

The foregoing disclosure provides illustration and description, but is not intended to be exhaustive or to limit the implementations to the precise form disclosed. Modifications and variations may be made in light of the above disclosure or may be acquired from practice of the implementations. Furthermore, any of the implementations described herein may be combined unless the foregoing disclosure expressly provides a reason that one or more implementations cannot be combined. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

As used herein, “a,” “an,” and a “set” are intended to include one or more items, and may be used interchangeably with “one or more.” Further, as used herein, the article “the” is intended to include one or more items referenced in connection with the article “the” and may be used interchangeably with “the one or more.” Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

1. A filtration device, comprising:
a securement section that is configured to be threadably secured to and extend within an interior of a common rail fuel injector,
wherein the securement section includes a passage for fuel,
wherein the passage extends in a direction along a central axis of the securement section; and
a filter extending from the securement section and configured to be positioned within the interior of the common rail fuel injector to filter the fuel flowing through the common rail fuel injector,
wherein the filter includes a plurality of holes that are fluidly connected to the passage of the securement section,
wherein a diameter of the filter is smaller than a diameter of the securement section.

2. The filtration device of claim 1, wherein the securement section is integrally formed with the filter.

3. The filtration device of claim 1, wherein each hole of the plurality of holes extends in a direction that is substantially perpendicular to the direction of the passage of the securement section.

4. The filtration device of claim 1, wherein
the passage of the securement section is a first passage; and
the securement section further includes a second passage that extends in a direction substantially perpendicular to the direction of the first passage,
wherein the second passage is positioned between the first passage and the filter.

5. The filtration device of claim 1, wherein the passage of the securement section defines a through hole that extends from a first end of the securement section to a second end of the securement section.

6. The filtration device of claim 5, wherein the filter further includes a substantially cylindrical body that forms a receptacle for debris particles within the fuel,
wherein the substantially cylindrical body includes:
an open end that is adjacent to the second end of the securement section,
a closed end, and
a wall connecting the open end to the closed end,
wherein the plurality of holes extend radially through the wall.

7. The filtration device of claim 1, wherein each hole of the plurality of holes extends in a direction that is substantially parallel to the direction of the passage of the securement section.

8. A fuel injector, comprising:
an inlet portion comprising:
an interior cylindrical surface having a first screw thread, and
an interior bottom surface,
wherein the interior cylindrical surface and the interior bottom surface together define a cavity having a first diameter;
a securement section comprising:
an exterior surface having a second screw thread to engage the first screw thread, and
a passage extending along a central axis of the securement section; and
a filter positioned within the cavity of the inlet portion of the fuel injector and extending between the first screw thread and the interior bottom surface, the filter comprising:
a plurality of holes that are fluidly connected to the passage of the securement section,
wherein the filter has a diameter that is less than a diameter of the cavity.

9. The fuel injector of claim 8, wherein the filter has a shape substantially in the form of one of:
a cylinder, or
a truncated cone.

10. The fuel injector of claim 8, wherein each hole of the plurality of holes is configured to filter fuel flowing from an interior side of the filter to an exterior side of the filter.

11. The fuel injector of claim 8, wherein an end of the filter abuts the interior bottom surface of the inlet portion.

12. The fuel injector of claim 8, wherein the interior cylindrical surface of the inlet portion further comprises a seat that supports an end of the securement section to provide a space between an end of the filter and the interior bottom surface of the inlet portion.

13. The fuel injector of claim 8, wherein
the interior cylindrical surface of the inlet portion further comprises a seat; and
the filter further comprises a flange,
wherein the flange is clamped between the seat and an end of the securement section to provide a space between an end of the filter and the interior bottom surface of the inlet portion.

14. The fuel injector of claim 8, wherein the fuel injector is a common rail fuel injector.

15. A fuel system, comprising:
a common rail; and
a plurality of fuel injectors configured to receive fuel from the common rail, a fuel injector of the plurality of fuel injectors comprising:
an inlet portion having a cavity that includes a first screw thread;
a securement section having:
a second screw thread to engage the first screw thread, and
a passage extending along a central axis of the securement section; and
a filter positioned within the cavity of the inlet portion of the fuel injector, the filter having a plurality of holes that are fluidly connected to the passage of the securement section,
wherein the inlet portion includes an interior surface forming the cavity, and the filter has a diameter that is less than a diameter of the cavity, such that a fuel path is formed between the filter and the interior surface.

16. The fuel system of claim 15, further comprising:
a plurality of fuel lines, a fuel line of the plurality of fuel lines extending between the common rail and the fuel injector,
wherein the securement section includes a third screw thread, and the fuel line includes a fourth screw thread to engage the third screw thread.

17. The fuel system of claim 15, further comprising:
a fuel tank that is configured to store the fuel therein; and
a pump that is fluidly connected between the fuel tank and the common rail to pressurize and deliver the fuel to the common rail.

18. The fuel system of claim 15, wherein the passage includes a tapered opening.

19. The fuel system of claim 15, wherein the filter is configured to prevent debris particles within the fuel from exiting the cavity.

20. The fuel system of claim 15, wherein the securement section and the filter are made of steel.
